(19) United States
(12) Patent Application Publication
(10) Pub. No.: US 2002/0095484 A1
(43) Pub. Date: Jul. 18, 2002

(54) Method and apparatus for efficiently configuring customer premesis equipment

(76) Inventors: Oscar Pagani, Corte Madera, CA (US); Craig P. Herro, Petaluma, CA (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/758,249

(22) Filed: Jan. 12, 2001

(51) Int. Cl. G06F 15/177

(52) U.S. Cl. 709/220

(57) ABSTRACT

Training and logistical problems associated with configuring customer premises equipment (CPE) are greatly reduced by providing a common interface through which technicians may interact with CPE during the configuration process. The common interface is uniform for diverse CPE equipment and does not require learning a new language for interfacing with each different type of CPE. The technician's mobile computer may be communicatively coupled to the CPE to provide the common interface. Additionally, the mobile computer may receive configuration data directly from a service provider database. The technician may then, through the common interface, automatically upload the received configuration data to the CPE without having to manually enter data.

### FIELD OF THE INVENTION

The present invention relates generally to communications and data processing and, more particularly, to a method and apparatus for configuring customer premises equipment used in providing communications services such as digital subscriber line (DSL) service.

### BACKGROUND OF THE INVENTION:

In recent years, there have been dramatic improvements in technologies that make bandwidth available for data and voice transmission. The improvements have resulted in an increase in available bandwidth and demand for bandwidth by individual consumers, businesses and educational institutions. Bandwidth increases have also increased the minimum bandwidth required to use and enjoy the Internet. These trends are ongoing and have created a constant demand for more bandwidth.

To provide bandwidth increases, some technologies utilize existing telecommunications networks, such as existing copper wire or cable television networks. Other technologies require the installation of new telecommunication networks using new copper wire, fiber optics or other connectivity to reach the houses or businesses of end users. In both cases, new customer premises equipment (CPE), located at an end user's house or business, is generally required. New CPE interfaces with the telecommunications network, typically using new signaling or protocol technologies, to increase available bandwidth.

One of the barriers to implementing new telecommunications technologies is the cost of installing and configuring CPE at each customer location. A large portion of the cost comes from “truck rolls,” the cost of sending technicians in a truck to a customer location to install and configure CPE. Truck roll costs are not only high, but they are front end loaded because the equipment must be installed and configured prior to the telecommunications company receiving service revenues. For these reasons, and in order to keep service pricing competitive, it is desirable to keep truck roll costs to a minimum. This is particularly true for companies launching nation-wide telecommunication network services, such as DSL, where truck rolls necessitate a mobile fleet and technician manpower in geographic markets throughout the country.

Consider, for example, implementing digital subscriber line (DSL) services. Installation and configuration of CPE, such as a router, requires physically connecting it to a DSL network and configuring the router with local area network (LAN) and wide area network (WAN) internet protocol (IP) address and other information. Traditionally, the installation part of this process requires a truck roll to deliver the router, attach a communications cable between a WAN port on the CPE and a DSL network port within the customer premises, and to configure the router to receive the DSL service.

The configuration of routers has historically been time consuming and has necessitated many truck rolls, including truck rolls during which a technician must return to the same customer premises to begin or continue to configure a piece of CPE that has been installed on a previous truck roll. The problems associated with configuring routers have included training and logistical problems. Training problems arise because there are many different types of routers, each of which has its own language and procedures for interacting with it. Technicians therefore have to install and configure many different types of routers at different customer premises. This has presented a training problem because the technicians performing installation need to be trained to configure several different types of routers. If the training has not been effective, the technician may take significantly longer to configure a router than is required. This may necessitate additional truck rolls either back to the same customer premises or to other customer premises for installations and configurations that were neglected as a result of configuration delay.

Logistical problems arise from providing the technician with the correct configuration information for each router, prior to the appointment and correctly entering such information into the router. This process has been performed by conveying configuration information orally or sending handwritten or typed information from a facsimile machine or email. Subsequently, the conveyed information has been typed into the CPE. This process is error prone and likely to cause significant additional delays, on average, over the course of many installations. This increases the number of truck rolls and therefore the cost of initiating service in a geographic market.

There is accordingly a need for techniques for configuring CPE that avoids or minimizes training and logistical problems. There is a further need to reduce or eliminate truck rolls required for installation of CPE to reduce the cost of rolling out high bandwidth services in various geographic markets.

### SUMMARY OF THE INVENTION

According to the present invention, training and logistical problems associated with configuring customer premises equipment (CPE) are greatly reduced by providing a common interface through which technicians may interact with CPE during the configuration process. The common interface is uniform for diverse CPE equipment and does not require learning a new language for interfacing with each different type of CPE. The technician's mobile computer may be communicatively coupled to the CPE to provide the common interface. Additionally, the mobile computer may receive configuration data directly from a service provider database. The technician may then, through the common interface, automatically upload the received configuration data to the CPE without having to manually enter data.

According to one embodiment of the present invention, a method is used to configure customer premises equipment. The method includes providing a mobile computer having a first interface for allowing a user to enter: a) identification information for customer premises equipment for configuration and b) configuration data for the customer premises equipment. It further includes providing a second interface for communication with the customer premises equipment. The customer premises equipment is coupled to the second interface. The mobile computer then automatically configures the customer premises equipment through the second interface based on the configuration data and the identification information.

The configuration data includes WAN IP data and LAN IP data. The WAN IP data may include, for example, an ISP router WAN IP address, a WAN IP CPE address, a WAN Subnet Mask, and DLCI data. The method further includes coupling the customer premises equipment to a communications network and issuing a ping command for execution by the customer premises equipment through the second interface.

In one embodiment of the invention, the method further includes downloading the configuration data to the mobile computer from a remote server. The downloading may be performed based on an order number. The method may further include uploading configuration results to the remote server after configuration.

In another embodiment of the present invention, a method configures customer premises equipment remotely without requiring, for example, a physically connected mobile computer. According to the method, a discover packet is received from customer premises equipment over a communications line. In response, WAN IP data is transmitted back to the CPE over the communications line. LAN IP data is retrieved based on an address of the communication line and transmitted over the communications line to the CPE. The CPE is configured based on the received WAN IP and LAN IP data. The communications line may be a DSL line coupled to a DSLAM, which may in turn include a DHCP server for determining the WAN IP data.

According to another embodiment of the present invention, a computer program product causes a computer to configure customer premises equipment. The computer program product may be a computer useable medium, such as a CD-ROM or floppy disk, having computer program logic stored therein wherein the computer program logic includes interface means for causing the computer to provide a first interface for allowing a user to enter: a) identification information for customer premises equipment for configuration and b) configuration data for the customer premises equipment and a second interface for communication with the customer premises equipment. The computer program product also includes configuring means for causing the computer to automatically configure the customer premises equipment through the second interface based on the configuration data and the identification information.

### BRIEF DESCRIPTION OF THE FIGURES

The foregoing features and advantages of the present invention will be more fully appreciated with reference to the detailed description and appended figures, in which:

FIG. 1 depicts an illustrative network for providing digital subscriber line service to subscribers in a region and equipment for configuring customer premises equipment according to an embodiment of the present invention.

FIG. 2 depicts a method of providing configuration data to configuration technicians and a method of tracking successful configurations according to an embodiment of the present invention.

FIG. 3 depicts a secure server for providing configuration data and tracking successful configurations according an embodiment of the present invention.

FIG. 4 depicts a method of configuring customer premises equipment using a mobile unit according to an embodiment of the present invention.

FIG. 5 depicts a screen displayed from the mobile unit that may be used to provide configuration data for a configuration according to an embodiment of the present invention.

FIG. 6 depicts a method of configuring customer premises equipment remotely over a network according to embodiments of the present invention.

### DETAILED DESCRIPTION

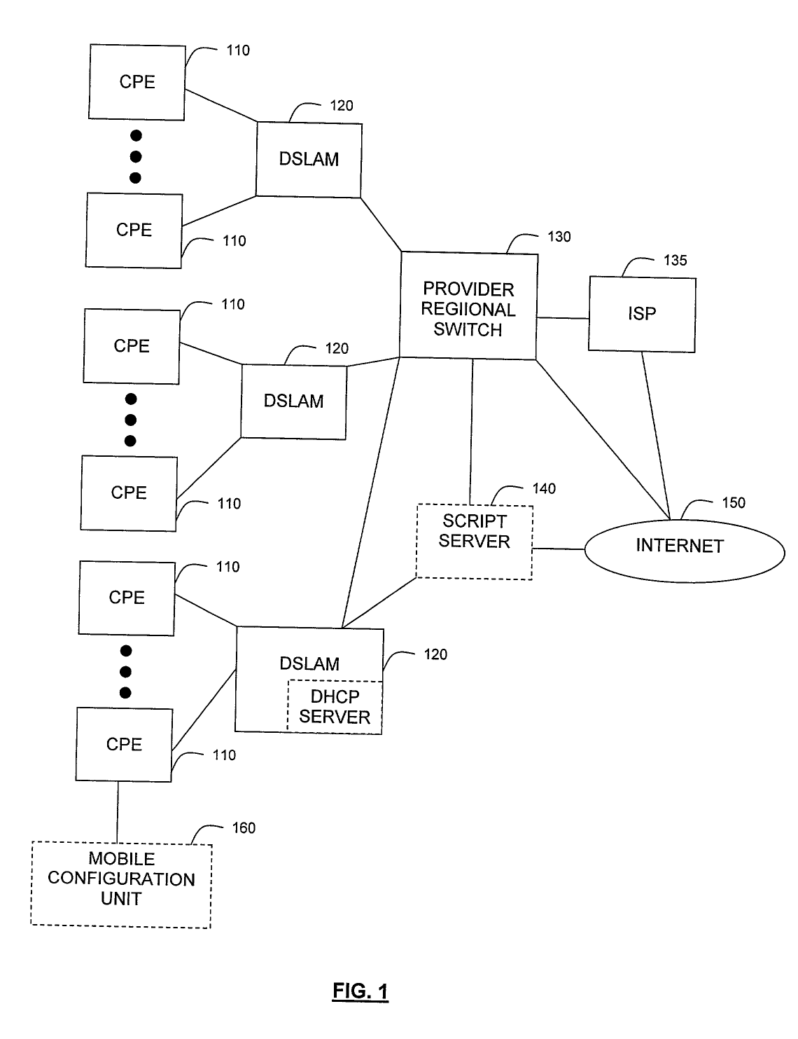

FIG. 1 depicts an arrangement for providing a regional telecommunications service for accessing the Internet, such as digital subscriber line (DSL) service. Referring to FIG. 1, the arrangement includes a provider regional switch 130, a plurality of digital subscriber line multiplexers (DSLAMs) 120, and a plurality of customer premises equipment (CPE) 110.

The DSLAMs 120 are typically situated at telephone company central offices. Telecommunication lines 115, such as copper wires, couple CPE 110 at subscriber locations to DSLAMs within the local area of the central office that includes the DSLAM 120. The DSLAMs 120 themselves couple many lines 115 to one or a few high-speed lines 125 to the provider regional switch. The line 125 may be, for example, an asynchronous transfer mode (ATM) line. There may be more than one DSLAM 120 in each central office.

The provider regional switch 130 is coupled between the DSLAMs 120 in a geographic region and the Internet 150. The provider regional switch 130 may also provide a connection to an internet service provider (135) that is unaffiliated with the regional provider. In this scenario, the regional service provider provides the infrastructure to access the Internet and must receive subscriber information from the ISP 135 to perform configuration of the CPE 110.

The CPE 110 may include a router which couples one or more local area networks to the internet. The CPE 110 may also or alternatively include a bridge, severs and computers. In the case of DSL service, the CPE 110 includes a DSL modem for transmitting and receiving DSL signals, over the line 115, to and from the DSLAM 120. The DSL modem may be part of a router, bridge, server or computer. DSL service is desirable because it offers more bandwidth than a telephone connection that does not include DSL signaling equipment.

In order to provide a telecommunication service such as DSL, the CPE, and in particular routers and bridges within the CPE, must be configured with configuration data in order to access the DSL service. In order to configure the CPE 110, a mobile configuration unit 160 or a script server 140 may be used. Both the mobile configuration unit 160 and the script server 140 for configuring CPE 110 are shown in FIG. 1.

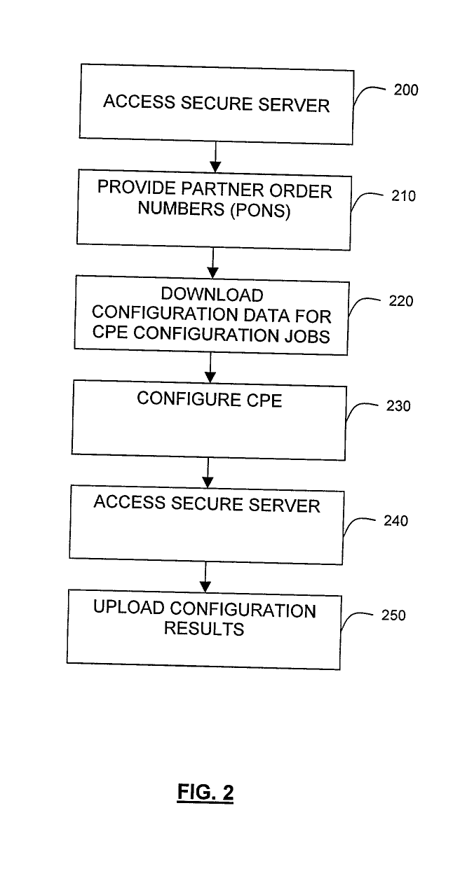

Referring to FIG. 1, the mobile configuration unit 160 may be, for example, a laptop computer or any other portable or hand-held device capable of establishing a communication link with a router, bridge or other telecommunications equipment that needs to be configured in the CPE. According to one embodiment of the invention, the mobile configuration unit is a portable computer that establishes a communication link via a serial bus connecting a serial port of the portable computer with a serial port on, for example, the CPE. The operation of the mobile configuration unit is described with reference to FIGS. 2-5.

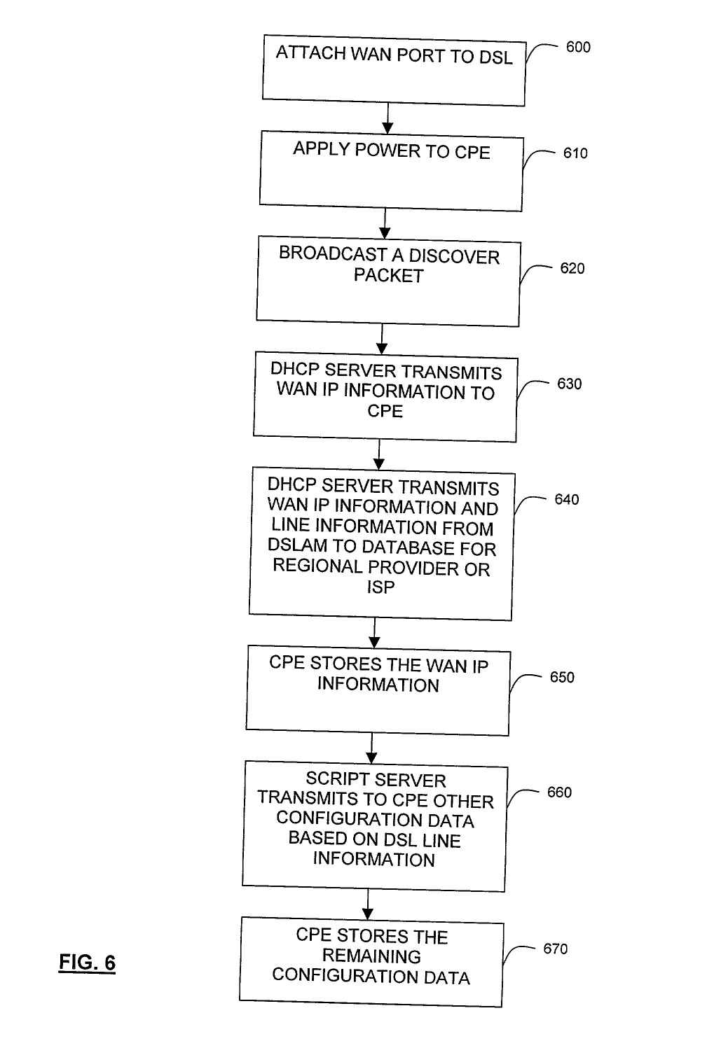

As an alternative to a mobile configuration unit, the script server 140 may be used to remotely configure CPE 110 via the DSL infrastructure. The script server 140 may be coupled, for example, to one or more of the DSLAMs 120 or to the provider regional switch 130 either directly or via a connection to the Internet 150. The operation of the script server 140 is described with reference to FIG. 6.

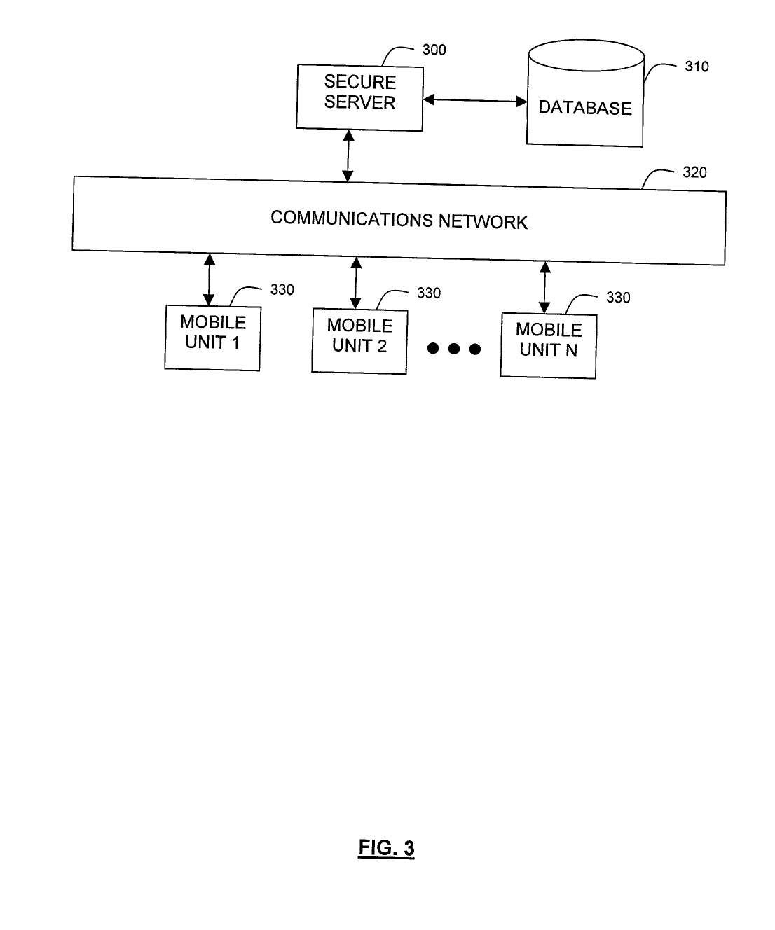

FIG. 2 depicts a method of providing configuration data to the mobile configuration unit for use in configuring CPE according to an embodiment of the present invention. In order to more fully appreciate the method of FIG. 2, reference is first made to FIG. 3. FIG. 3 depicts a secure server for providing configuration data to mobile units and for tracking successful configuration of CPE. Referring to FIG. 3, a secure server 300 is coupled between a database 310 and a communications network 320. The network 320 may be a local area network, a wide area network, the public switched telephone network, the interconnected backbones, routers, bridges, switches and servers known as the Internet, other communications links and combinations thereof. The network 320 may include direct electrical connections, wireless, optical or any other communications links, including analog, digital, circuit switched and packet switched, for transmitting information. Mobile configuration units 160 may access the secure server 300 over the network 320 to obtain information and configuration data from the database 310.

Reference is again made to FIG. 2 where a method of configuring and tracking configuration is illustrated. Referring to FIG. 2, in step 200, a mobile unit 160 accesses the secure server 300 over the communications network 320. As part of the access processes, a user of the mobile unit may be prompted for a user id and password. Once access has been granted, the user, who is typically a technician that performs CPE configuration and/or inside wiring, is able to retrieve appointments by order number and other useful information such as configuration instructions from the database 310.

In step 210, the user provides order numbers to the secure server 300. This may be performed, for example, by the user interacting with a file or page served by the secure server to the mobile unit 160. The user may be made aware of the order numbers that are assigned to the user in a number of different ways. In one scenario, the user receives order numbers to which he is assigned by facsimile or electronic mail. In another scenario, the user receives order numbers orally. In still another scenario, the order numbers for the user are stored in association with the user id of the user. In the latter scenario, step 210 may be omitted or the user may be prompted to select from a list of order numbers that have been assigned to the user and retrieved from the database. This may be performed by the user highlighting order numbers from, for example, a pop-up menu that is served as part of an interactive file or page.

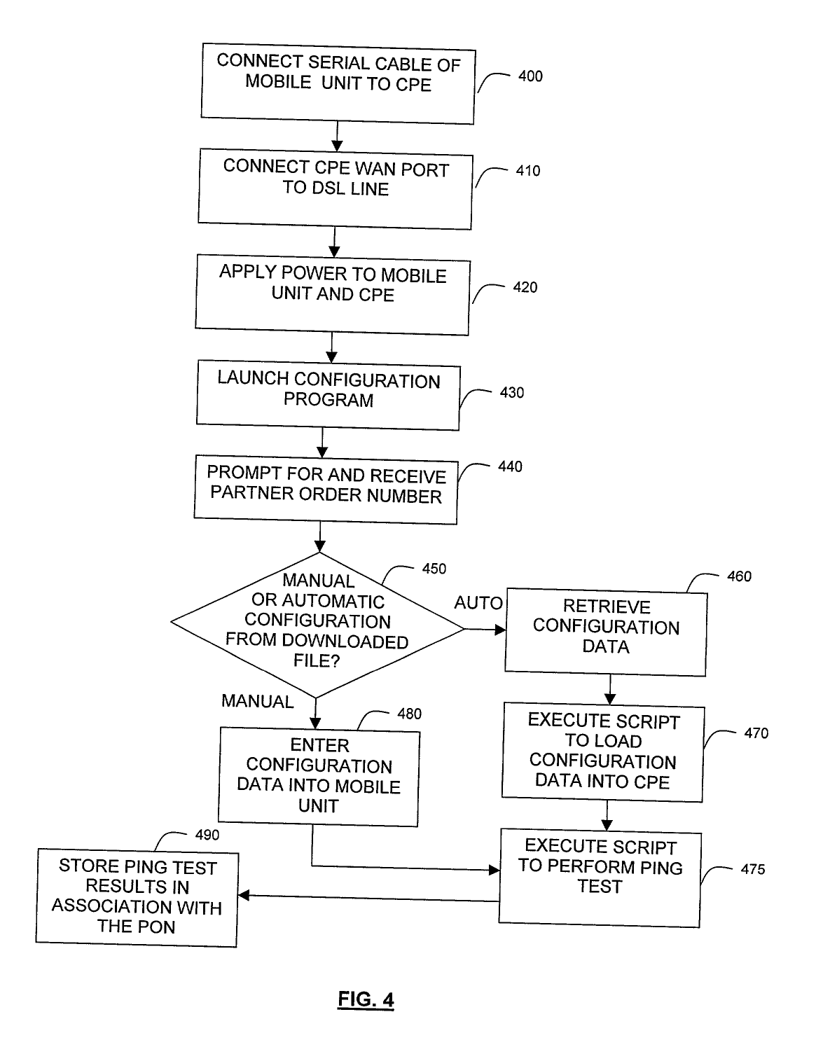

In step 220, the mobile unit 160 downloads and stores configuration data for CPE configuration appointments that correspond to order numbers selected in step 210 or otherwise associated with the user. Then in step 230, the user uses the mobile unit 160 to configure CPE. The method of configuring the CPE using the mobile unit 160 is described below with reference to in FIG. 4. The process includes uploading configuration data to the CPE and performing a ping test in which communication continuity between the CPE, the DSLAM, the regional provider switch and, when present, the ISP is established. Results of the ping test, as well as any modifications necessary to the configuration data are stored on the mobile configuration unit 160.

After completing one or more configurations of CPE, the user may again access to the secure server 300 in step 240 by logging on via the communications network 320. Then in step 250, the mobile unit 160 uploads configuration results to the server 300. This may be performed through interaction with a page or file served by the secure server. For example, the user may be prompted to synchronize configuration data between the mobile unit 160 and the configuration data stored in the database 310. The synchronization may be performed using any convenient protocol, including hypertext transfer protocol (http), telnet, file transfer protocol (ftp) or any other convenient protocol. In general, a successful or unsuccessful conclusion of the ping test from the configuration of the CPE is uploaded to the database 310 as part of the synchronization process. When a CPE has been successfully configured as noted by a successful ping test, the order number may be removed from the queue of order numbers waiting to be provided to users such as inside wiring technicians. Conversely, if configuration for a CPE specified by a particular order number has either not been attempted or unsuccessfully attempted, this information may be stored in the database in association with the order numbers. These order numbers, in consequence, will not be removed from the queue of orders numbers that need to be assigned to users.

If any configuration data is changed during the configuration process, such as a WAN IP address or other information, this information may be correctly stored in the mobile unit 160 but incorrectly stored in the database 310. In this scenario, the synchronization process may be used to update the configuration data in the database 310 with the most recent data from the mobile unit 160. Synchronization may be performed weekly, daily, twice daily or at any other convenient frequency which assures that the queue of orders stored in the database 310 is accurate and that users of the mobile units 160 have accurate information about configuration appointments that they must keep.

FIG. 4 depicts a method of configuring customer premises equipment using a mobile unit 160 according to an embodiment of the present invention. The method of FIG. 4 presumes that a user has arrived at a subscriber's physical location to install and configure one or more pieces of CPE. Accordingly, the user may receive information from the secure server which directs the user to different subscribers based on the order numbers assigned to the user at different times. Once the user is in close proximity to the CPE for configuration, the method of FIG. 4 begins.

Referring to FIG. 4, in step 400, the user of the mobile unit 160 connects a serial cable between a serial port on the mobile unit and a serial port on the CPE for configuration. In one embodiment, this is performed with power to both the CPE and the mobile unit off. The CPE for configuration may be, for example, a router, a bridge, a server or a computer. As an alternative to a serial cable, the laptop and the CPE for configuration may be connected via any convenient communications link including a wireless or optical link communications link.

In step 410, the user connects the WAN port of the CPE 110 to the DSL line 115, which provides access to the local DSLAM 120 and the network services offered by the regional provider and/or the ISP.

In step 420, the user applies power to both the mobile unit 160 and the CPE 110 if power has not already been applied. Then in step 430, the user launches a configuration program on the mobile unit 160 which performs the steps 440-490. In step 440, the user is prompted to enter an order number for the CPE that the user is configuring. Then in step 450, the user determines whether automatic or manual entry of configuration data is to be used. This determination may be made based on whether or not configuration data associated with the order number is retrievable from storage on the mobile unit 160. If so, automatic entry of the configuration data downloaded from the secure server 300 may be used during the configuration process. Alternatively, the user may manually enter the configuration data by interacting with the configuration program.

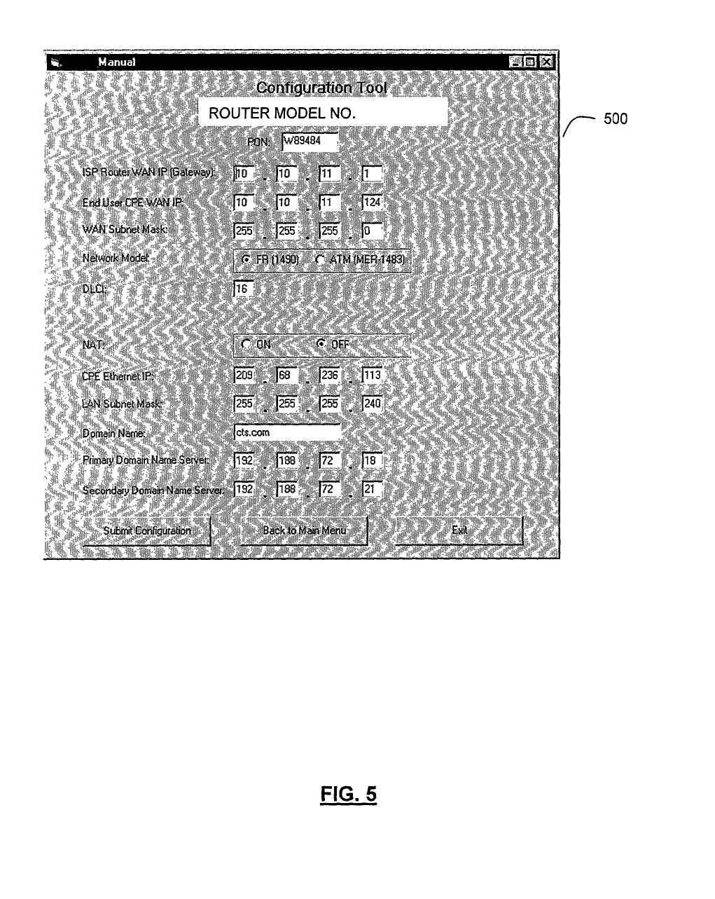

When entry of the configuration data is automatically performed, the configuration data is automatically retrieved from storage on the mobile unit 160 based on the order number entered in step 440. The retrieved data may populate a screen that is displayed to the user as illustrated in FIG. 5. When the configuration data is to be manually entered, the user may be presented with a manual entry screen as shown in FIG. 5. The user may manually enter data into each of the required fields. For some of the fields, the user may select from a menu of options presented in, for example, a pop-up menu. An example of data that is convenient to include in a pop-up menu is the type of CPE which is to be configured. The configuration program may only work with certain types, or models of CPE. The list of “known” CPE may thus be conveniently included in a pop-up menu for the user to select among.

Once the configuration data has been automatically or manually provided to the mobile unit 160, then in step 470 the user may select to execute a script to automatically load the configuration data via the serial port (or other link) into the CPE. The script includes commands and the configuration data for performing load operations and for monitoring whether the load operations succeeded or failed. In the event of failure, the load operations may be retried. The script is typically different for each different type of configuration equipment or among different manufacturers or models of the same piece of equipment. This difference has led to confusion among configuration technicians in the field. Embodiments of the present invention eliminate this confusion presenting a common interface to the user, namely the configuration software. The mobile unit 160 executes the software to select the appropriate script and command language to use during configuration in a way that is transparent to the user.

Once the configuration program successfully loads the configuration data into the CPE, the mobile unit executes a program to issue a command over the serial link to cause the CPE to execute a ping command. The ping command causes the CPE to transmit information, typically packets of information, over the DSL line to the provider regional switch or the ISP. The information or packet causes the receiving equipment to reply with confirmation information or packets. If the CPE 110 successfully receives the confirmation information or packets, the CPE 110 has been successfully configured. The results of the ping test are stored in the mobile unit 160 in step 490. The results may be automatically transferred to the mobile unit 160 in response to a command issued from the mobile unit that is part of a ping test script. Alternatively the ping test results may be manually entered into the mobile unit 160. In either case, the ping test results, whether successful or not, are stored in association with the order number on the mobile unit 160. This information may be used in subsequent synchronization with the secure server 300.

If the ping test is unsuccessful, the user may repeat the ping test. Alternatively, the user may repeat the entry of configuration data with the same or new data and then retry the configuration test.

FIG. 6 depicts an alternate embodiment of the invention, in which the script server 140 illustrated in FIG. 1 performs configuration of the CPE 110 remotely. The method depicted in FIG. 1 still requires someone to physically connect the WAN port of the CPE 110 to the DSL line 115 and then apply power to the CPE 110. This may be performed in steps 600 and 610 by an inside wiring technician who performs installation of the CPE 110. Alternatively, it may be performed by the subscriber who receives the CPE 110 and an instruction manual indicating the manner of connecting and powering up the CPE 110.

Upon application of power to the CPE 110, the CPE 110 may broadcast a “discover” packet over the DSL line 115. The discover packet is a request for configuration data that may be used for the present connection session only or for a longer duration including as long as the service is subscribed to. The discover packet is received by the DSLAM and routed to a dynamic host configuration protocol server (DHCP) that is associated with or within the DSLAM 120.

Then in step 640, the DHCP server determines WAN IP data that is to be used as a portion of the configuration data by the requesting CPE 110. Subsequently, the DHCP server transmits the WAN IP data to the CPE via the DLAM 120. The WAN IP data may include the ISP Router WAN IP gateway address, the end user CPE WAN IP address, the WAN Subnet Mask data, the Network Model and or the DLCI. The DHCP server also transmits the WAN IP data and the address of the DSP line 115 from which the discover packet was received to a database associated with the regional provider and/or the ISP that administers the service. Based on the address of the DSP line 115 from which the discover packet was received, the WAN IP data is stored in association with subscriber information in the database.

In step 650, the CPE receives and stores the returned configuration data, including the WAN IP data, from the DHCP server and may use the configuration data to access the DSL or other service. In step 660, the script server transmits to the CPE a configuration script that is to be executed by the CPE 110. The configuration script includes configuration data such as LAN IP data including NAT data, CPE Ethernet IP data, LAN Subnet Mask data, Domain Name data, Primary Domain Name Server data and/or Secondary Domain Name Server data. The script server may identify the LAN IP data based on the DSL line address.

The terms mobile unit and mobile configuration unit have been used interchangeably and are intended to have the same meaning. The mobile unit may be implemented as a general purpose computer system. The general purpose computer system may include an input/output unit which may collectively comprise a display, a printer, speakers, a keyboard, a mouse or other pointing device, a speech or handwriting recognition device and any other input/output devices. The general purpose computer system may further include a modem for connection to the communications network 320, a memory for storing program instructions and data received from the communication network 210 and a processor, coupled to the memory, input/output unit and the modem, for executing the program instructions.

Each of the methods depicted in FIGS. 2, 4 and 6 and the methods described in the text may be implemented in software as program instructions executed by the processor of a general purpose computer system. The program instructions for the configuration programs and methods disclosed herein may be stored within a computer usable medium, such as a hard or floppy disk, a compact disc (CD) read only memory (ROM), a ROM, a file sent over a network or other vehicle for storing and/or delivering information to a computer. The program instructions corresponding to the configuration programs and methods disclosed herein may be uploaded to the memory by devices corresponding to the medium, such as hard disc drives, and the program instructions may be executed by the processor of a general purpose computer to cause the computer to execute the steps shown and described.

It will further be understood that the mobile unit may be implemented as a hand-held device, such as a device that is optically or wirelessly connected to the communications network 320 and otherwise operates in accordance with the same principles as a general purpose computer system as described above.

While specific embodiments have been disclosed, it will be understood by those having ordinary skill in the art that changes may be made to those embodiments without departing from the spirit and scope of the invention. For example, DSL service and DSLAMs have been used to illustrate configuration of CPE, it will be understood that CPE for any other communication service may be configured according to the principles and methods disclosed herein.

What is claimed is:

1. A method of configuring customer premises equipment, comprising:
providing a mobile computer having a first interface for allowing a user to enter:
a) identification information for customer premises equipment for configurafion and
b) configuration data for the customer premises equipment and a second interface for communication with the customer premises equipment; and
coupling the customer premises equipment to the second interface;
wherein the mobile computer automatically configures the customer premises equipment through the second interface based on the configuration data and the identification information.

2. The method according to claim 1, wherein the configuration data includes WAN IP data.

3. The method according to claim 2, wherein the configuration data includes a LAN IP data.

4. The method according to claim 2, wherein the WAN IP data includes an ISP router WAN IP address.

5. The method according to claim 4, wherein the WAN IP data further includes a WAN IP CPE address.

6. The method according to claim 5, wherein the WAN IP data further includes a WAN Subnet Mask.

7. The method according to claim 6, wherein the WAN IP data further includes DLCI data.

8. The method according to claim 1, further comprising:
coupling the customer premises equipment to a communications network; and
issuing a ping command for execution by the customer premises equipment through the second interface.

9. The method according to claim 1, further comprising:
downloading the configuration data to the mobile computer from a remote server.

10. The method according to claim 9, wherein the downloading is performed based on an order number.

11. The method according to claim 9, further comprising uploading configuration results to the remote server.

12. A method of configuring customer premises equipment, comprising:
receiving a discover packet from customer premises equipment over a communications line;
transmitting WAN IP data over the communications line to the CPE;
retrieving LAN IP data based on an address of the communication line;
transmitting the LAN IP data over the communications line to the CPE; and
wherein the CPE is configured based on the received WAN IP and LAN IP data.

13. The method according to claim 12, wherein the communications line is coupled to a DSLAM.

14. The method according to claim 13, wherein the DSLAM includes a DHCP server for determining the WAN IP data.

15. A computer program product for causing a computer to configure customer premises equipment comprising a computer useable medium having computer program logic stored therein wherein the computer program logic comprises:
interface means for causing the computer to provide a first interface for allowing a user to enter:
a) identification information for customer premises equipment for configuration and
b) configuration data for the customer premises equipment and a second interface for communication with the customer premises equipment; and
configuring means for causing the computer to automatically configure the customer premises equipment through the second interface based on the configuration data and the identification information.

16. The computer program product according to claim 15, wherein the configuration data includes WAN IP data.

17. The computer program product according to claim 2, wherein the configuration data includes a LAN IP data.

18. The computer program product according to claim 16, wherein the WAN IP data includes an ISP router WAN IP address.

19. The computer program product according to claim 18, wherein the WAN IP data further includes a WAN IP CPE address.

20. The computer program product according to claim 19, wherein the WAN IP data further includes a WAN Subnet Mask.

21. The computer program product according to claim 20, wherein the WAN IP data further includes DLCI data.
